(19) United States
(12) Patent Application Publication
(10) Pub. No.: US 2017/0106727 A1
(43) Pub. Date: Apr. 20, 2017

(54) Windshield Tear-Offs

(71) Applicant: Isaac Shipley, Lincoln, ND (US)

(72) Inventor: Isaac Shipley, Lincoln, ND (US)

(21) Appl. No.: 14/883,268

(22) Filed: Oct. 14, 2015

(51) Int. Cl. B60J 1/20; B60J 11/08

(52) U.S. Cl. CPC B60J 1/2005; B60J 11/08

(57) ABSTRACT

Disclosed herein is a transparent protective covering to protect a windshield from bugs encountered during travel on highways or freeways. In a preferred embodiment, the invention aims to provide a transparent structure used for the protection of a windshield. The structure according to the invention is comprised of a plurality of transparent films that are coupled together, wherein the transparent film has a first side, a second side, and at least one film removing means at one of the edges of the transparent film. The removing means is provided using a thin string attached to each of the transparent films, which tears the film.

### CROSS REFERENCE TO RELATE APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates generally to the field of protective coverings for windshields, and, more specifically, to a transparent laminated structure that has multiple peel-away film layers for protecting the windshield. The outer film layers have features for aiding in their removal.

(2) Background

As is well known, in warm, dirty climates, bugs, dirt, and rocks collect on the windshields and windows of automobiles, trucks, vans, and other vehicles that are parked outdoors. It is usually a troublesome and difficult task to remove sufficient amounts of such bugs, dirt, and rocks. Although many people typically use available car washes and truck stops to clean the bugs, dirt, and rocks, these windshield tear-offs help prevent the truckers from having to clean their windshield in the first place.

### BRIEF SUMMARY OF THE INVENTION

The primary objective of the invention is to provide a transparent protective covering to protect a windshield from bugs encountered during travel on highways or freeways.

Furthermore, in a preferred embodiment, the invention aims to provide a transparent structure used for the protection of a windshield. The structure is comprised of a plurality of transparent films that are coupled together, wherein the transparent film has a first side, a second side and at least one film removing means at one of the edges of the transparent film. The removing means is provided using a thin string attached to each layer of the transparent film, which tears the film.

A bonding layer is disposed on the first side of the transparent film for release-ably attaching the film. Furthermore, the covering has a hard coating disposed on the second side of the transparent film. The transparent structure has a transparent rigid layer for attaching the plurality of transparent films to the windshield without creating an air bubble. The coupling of the plurality of transparent films is done to attach the first side of one transparent film to the second side of another transparent film.

In its embodiments, the films used to form the transparent structure are made of a water-resistant plastic material. The structure provides a means for protecting said windshield form the impact of gravel, and also as a means to remove scratches, stains, and dirt from windshields.

The summary is provided to introduce a selection of concepts, in a simplified form, that are further described below in the detailed description. This summary is not intended to identify key features or essential features of the claimed subject matter, nor is it intended to be used as an aid in determining the scope of the claimed subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1 illustrates the prospective view of invention, with various components of the device.

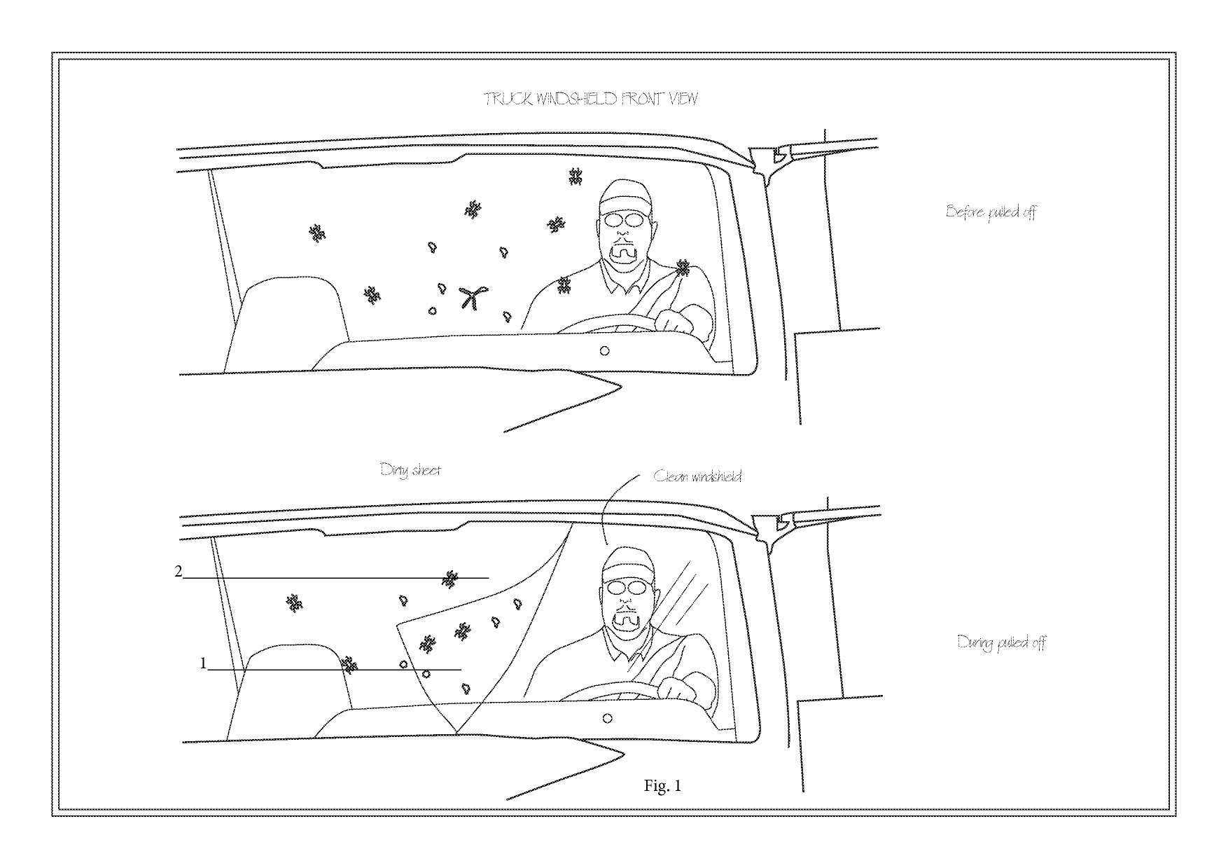

### DETAILED DESCRIPTIONS OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Referring to FIG. I thereof, it is shown that the invention provides a transparent structure used for the protection of a windshield. The custom sized thin, strong sheets made of plastic with one sticky side 1 and one non-sticky side 2. The transparent film has two sides: a first side, and a second side. The first side of the transparent film is for release-ably attaching the film. Furthermore, the covering has a hard coating disposed on the second side of the transparent film.

The coupling of the plurality of transparent films is done to attach the first side of one transparent film to the second side of another transparent film. The sheets are stacked together in a group of up to twenty, depending on thickness and visibility. The thin sheets would then be placed on top of a harder laminate type sheet that is a transparent rigid layer. This provides an easy way for the customer to apply the sheets to the window without having to take it to a specialist. It also prevents air bubbles from forming while disposing the sheets over the windshield.

After coupling the soft sheets and hard sheet, a thin strip of tape (the width of the stacked sheets) would be placed around the edge of the stack to act as a wind barrier and stop the wind of the moving vehicle to blow between the sheets, which would cause them to peal apart. The sheets would be applied to the window by cleaning the window and then rolling the sheet onto the window to stick on.

A film removing means at one of the edges of the transparent film is also provided. The removing means is provided using a thin string attached to each of the transparent film, which tears the film. The sheets would also have a corner tab for an easy means of grabbing each individual layer at time of tear off. The tabs would be connected to a thin fishing line type string, which would start at the top passenger window side of the tear off and follow along the top of the tear offs to the bottom drivers side to a small little tab with a number attached to it, labeling which layer each string is attached to. These strings would provide an easy way to remove the tear off without having to climb over the vehicle to grab the tab from the far side.

The sheets would provide an easy and instantaneous means of cleaning a windshield of bugs, dirt, and rain stains. The layer of sheets would also provide a means of preventing rock chips by absorbing the impact before the rock reaches the window.

The transparent sheets may be in groups of up to 20 sheets, and would be applied to the window by either the customer or a professional glass shop, depending on the difficulty to install it without air bubbles. Each layer would then be individually removed by the customer with a corner pull tab any time they feel their window is dirty enough to remove a layer.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is manifestly intended that this invention be limited only by the claims and the equivalents thereof.

Although the invention has been explained in relation to its preferred embodiment, it is to be understood that many other possible modifications and variations can be made without departing from the spirit and scope of the invention.

I claim:

1. A transparent structure used for the protection of a windshield comprising:
a plurality of transparent films coupled together, wherein said transparent films have a first side, a second side, and at least one film removing means at one edge of said transparent film;
a bonding layer disposed on said first side of said transparent film for release-ably attaching said film;
a hard coating disposed on said second side of said transparent film; and
a transparent rigid layer for release-ably attaching said plurality of transparent film coupled together for convenient attaching of said structure of transparent film to said windshield.

2. The transparent structure used for the protection of a windshield of claim 1, wherein said film removing means is comprised of a tearing means of said transparent film.

3. The transparent structure used for the protection of a windshield of claim 1, wherein said removing means is provided using a thin string attached to each said transparent film.

4. The transparent structure used for the protection of a windshield of claim 1, wherein coupling of said plurality of transparent film is done to attach said first side of one said transparent film to said second side of another said transparent film.

5. The transparent structure used for the protection of a windshield of claim 1, further provides a means for protecting said windshield form an impact of gravels.

6. The transparent structure used for the protection of a windshield of claim 1, wherein said film is water-resistant material.

7. The transparent structure used for the protection of a windshield of claim 1, wherein said film provides a means for removing stains on said windshield.

8. The transparent structure used for the protection of a windshield of claim 1, wherein said film provides a means for removing scratch marks on said windshield.

9. The transparent structure used for the protection of a windshield of claim 1, wherein said film provides a means for removing dirt on said windshield.

10. The transparent structure used for the protection of a windshield of claim 1, wherein said transparent rigid layer provides a means for attaching said transparent structure without creating an air bubble while disposing said transparent structure on said windshield.

11. The transparent structure used for the protection of a windshield of claim 1, wherein said films are made of plastic.
